(19) United States
(12) Patent Application Publication
(10) Pub. No.: US 2001/0012271 A1
(43) Pub. Date: Aug. 9, 2001

(54) IMPROVED ACKNOWLEDGEMENT OF BANDWIDTH REQUESTS FOR THE BLOCK TRANSFER OF DATA

(76) Inventor: ARTHUR W. BERGER, FAIR HAVEN, NJ (US)

Correspondence Address: MR S H DWORESKY, A T AND T CORP, P O BOX 4110, MIDDLETOWN, NJ, 07748

(21) Appl. No.: 08/905,560

(22) Filed: Aug. 4, 1997

(51) Int. Cl. H04L 12/56

(52) U.S. Cl. 370/230; 370/389

(57) ABSTRACT

Acknowledgment of acceptance of a request for bandwidth for a block transfer connection is delayed at the public network side of a boundary between a public network and a private destination network. As a result, each network element within the private destination network can either reject or reduce the requested rate encoded in a resource management (RM) cell to a level that the network element can grant. An acknowledgment RM cell is only then issued from the private destination network, which indicates either acceptance, rejection, or acceptance at a lower rate. When the source of the connection receives the acknowledgment RM cell from the private destination network, it begins to transmit at a rate that the private destination network and destination end system can support.

### RELATED APPLICATIONS

This application is related to copending U.S. Application Ser. No. ______, entitled “FLEXIBLE BANDWIDTH NEGOTIATION FOR THE BLOCK TRANSFER OF DATA”, filed Jun. 4, 1997, assigned to AT&T, which is incorporated by reference herein.

### FIELD OF THE INVENTION

The present invention relates to a system and method for transmitting blocks of data between network nodes and end systems coupled to a network. Specifically, the system and method provide capability for a network node or end system within a private network to initiate and send the acknowledgment through a public network indicating that the private network accepts or rejects a requested rate of transmission.

### BACKGROUND OF THE INVENTION

Asynchronous transfer mode (ATM) involves the transfer of data in discrete digital packets between two end systems coupled to a network. The discrete packets of data are known as cells. ATM block transfer (ABT) is an ATM transfer capability in which data is partitioned into blocks of data cells that are delineated by resource management (RM) cells, which contain stored information to describe the characteristics desired for transfer of the ensuing blocks of data cells. For example, an ABT RM cell contains a value stored in a block cell rate (BCR) field, which represents the maximum rate at which the subsequent block of data cells may be transmitted.

In block transfer capabilities, a source or network element may request a new, or higher block cell rate to be supported by end systems or network nodes on the network. The following scenario illustrates how such a request is handled by existing public and private networks with reference to FIG. 3. A source end system is coupled to a destination end system through a plurality of public and private network nodes, via an ATM connection. Both the source and destination end systems reside within private networks, each of which includes a plurality of private network nodes, some of which participate in the ATM connection.

When the source end system needs to send a block of data, it initiates a request, for a specific block cell rate (BCR), to the destination end system. The request is made by the source issuing an ABT RM cell on the previously established connection requesting the network to allocate bandwidth to the connection at the desired block cell rate.

After issuance from the source, the ABT RM cell continues along the connection toward the destination end system, stopping at each network node along the connection. Each network node upon receipt of the ABT RM cell may grant or reject the requested BCR. Upon granting the requested rate, each network node forwards the RM cell to the next network node.

In existing block transfer capabilities, when the public network node (herein called the “egress public-network node”) at the boundary between the public network and the private network that includes the destination accepts the request RM cell, it forwards the request RM cell to the private network for further acceptance or rejection. The public network node also generates an acknowledgment RM cell and transmits it back to the source end system. The acknowledgment RM cell indicates that the request has been granted so that the source can begin to send data at the requested rate. This creates a problem.

The acknowledgment RM cell sent by the public network node is misleading because the requested rate has not yet been granted by the network elements of the private network. Any one of these network elements along the connection may still reject the requested BCR. In fact, the private network nodes are more likely to reject the request than the public network nodes if the private networks are more tightly engineered. Network nodes of a private network are commonly slower and less sophisticated than network nodes within public networks, which are designed to handle large volumes of voice and data traffic at very high rates. Similarly, the source end system may be much more sophisticated than the destination system. In these instances, the source may request and the public network may prematurely accept a higher transmission rate than the destination system can handle.

When a network element within the private destination network rejects a request RM cell that the public network has already granted and acknowledged via an acknowledgment RM cell, the following occur. Based on the acknowledgment RM cell received from the public network, the source begins to transmit data to the destination at the granted rate. This rate is more than the destination can handle and results in either loss of data at the private destination network or a requirement that the private destination network include high speed buffers to receive blocks of data that arrive too fast for the private destination network to route. Such a requirement is costly to implement and therefore is undesirable. Transmission from the source at the increased granted rate will continue until a cell, issued from the private destination network, is received by the source indicating that the requested rate is too high and is therefore rejected.

### SUMMARY OF THE INVENTION

The deficiencies of acknowledging acceptance of a request for bandwidth at the public network side of a boundary between a public and a private network described above are remedied by delaying acknowledgment of acceptance. Each network element within the private destination network can then either reject or reduce the requested rate encoded in a RM cell to a level that the network element can grant. The acknowledgment RM cell is then issued (along the companion backward ATM connection) from the private destination network, and indicates either acceptance, rejection, or acceptance at a lower rate. The acknowledgment RM cell is then relayed by each network node (including the egress public network node) along the path of the connection. Thus, when the source receives the acknowledgment RM cell from the private destination network, it begins to transmit at a rate that the private destination network and destination end system can support.

The egress public-network node delays acknowledgment of a rate request for a block transfer connection, and includes ingress and egress links coupled respectively to a public and a private network. A control unit within the network node is coupled to the ingress and egress links. It receives from the public network a request cell having an encoded rate request, the purpose of which is to establish a different transmission rate for the connection. In response to the request cell, the control unit generates an acknowledgment cell only if the rate request is denied. The control unit transmits the request cell along the connection to the private network for further review of the rate request by the private network, which may still accept, accept at a lower rate, or deny the rate request.

A method for propagating a rate request along a block transfer connection between a source and a destination, includes the following steps. A request cell having an encoded rate request for a connection is issued to a network. The request cell is transmitted across a boundary of the network located between a public network portion and a private network portion of the network. The private network portion includes a destination system for the connection. An acknowledgment cell is generated, in response to the request cell, only from within the private network unless the rate request is rejected. The acknowledgment cell is transmitted to the source and indicates the status of the rate request.

### BRIEF DESCRIPTION OF THE FIGURES

The invention is more fully described with reference to the accompanying figures and detailed description.

FIG. 1 depicts a network including a plurality of end systems and network nodes coupled together.

FIG. 2 depicts a table of stored information fields contained within a resource management cell.

FIG. 3 illustrates a network having two private networks coupled together through a public network.

FIG. 4 depicts an interaction between a source system and a destination system over a network during a rate request issued from the source to increase bandwidth for a block transfer connection.

FIG. 5 depicts an interaction between a source system and a destination system over a network during a rate request issued from a network node to increase bandwidth for a block transfer connection.

FIG. 6 depicts an exploded view of a network node that illustrates the component parts of the network node.

FIG. 7 depicts a method for delaying acknowledgment of a rate request encoded in an RM cell.

### DETAILED DESCRIPTION OF INVENTION

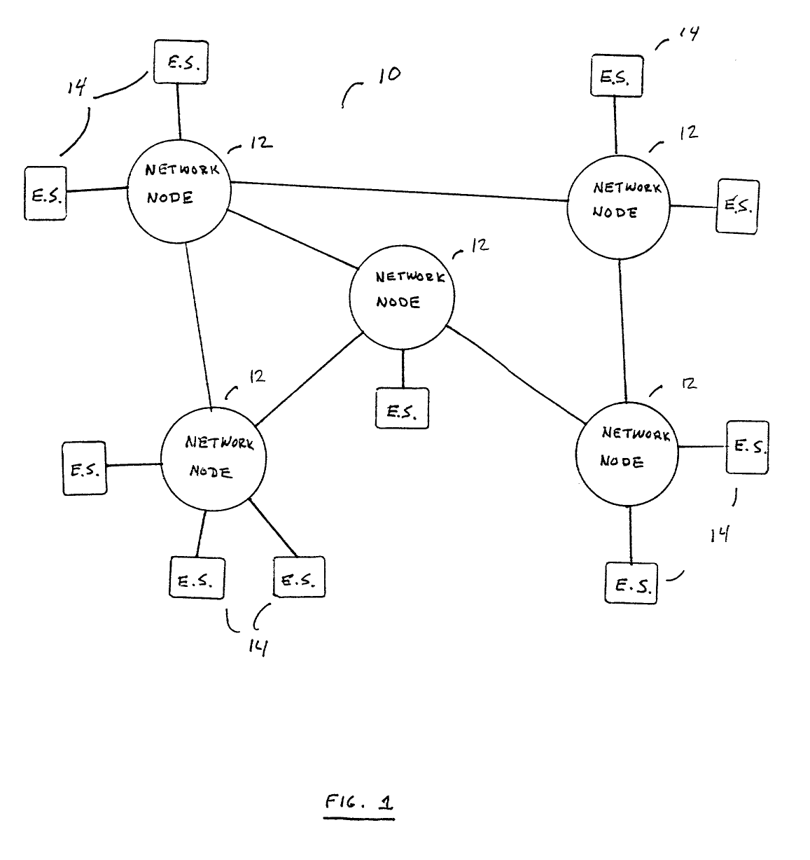

FIG. 1 depicts a network 10 in which the invention finds application. The network 10 includes a public network, such as the public telephone network and a plurality of private networks such as a local area network interconnecting offices within a company. Referring to FIG. 1, the network 10 includes network nodes 12 and end systems 14 collectively referred to as network elements. The network nodes 12 and end systems 14 are coupled together, for example electrically, optically, or wirelessly, thus enabling the exchange of information between end systems 14 and network nodes 12 and any combination thereof on the network 10. The network nodes 12 may represent telephone switching equipment, cross connects, or customer premises equipment, that is geographically dispersed over a large region. Conversely, each network node 12 may represent a server or router, and may be a single machine or may be distributed across a plurality of machines.

The end systems 14 that are coupled to the network nodes 12 may be a single computer or a gateway to a local or wide area network that includes a plurality of computers coupled to the network 10. The end systems 14 of FIG. 1 may also be a private branch exchange (PBX) systems of a telephone network that is capable of transmitting and receiving digital packets of information such as in a broadband integrated services digital network (B-ISDN). The end systems 14 of FIG. 1 define the extremities of a network 10 in which a digital block transfer protocol such as the asynchronous block transfer protocol is capable of implementation.

Two end systems 14 may transmit data to each other in digital packets called cells, for example, using an asynchronous transfer mode (ATM). When such transmission of data takes place over the network 10, there are two ATM connections. One transporting ATM cells in one direction and the other transporting ATM cells in the opposite direction. Consider one of these connections; the end system 14 that is emitting cells onto this connection is the “source”, and the end-system 14 receiving these cells is the “destination”. The direction from the source to the destination is the “forward” direction. The companion ATM connection transmits cells in the “backward” or “reverse” direction. The term connection, as used herein, includes a virtual connection, virtual channel connection, and virtual path connection within the context of asynchronous transfer mode, and the flow of packets in the context of an internet protocol.

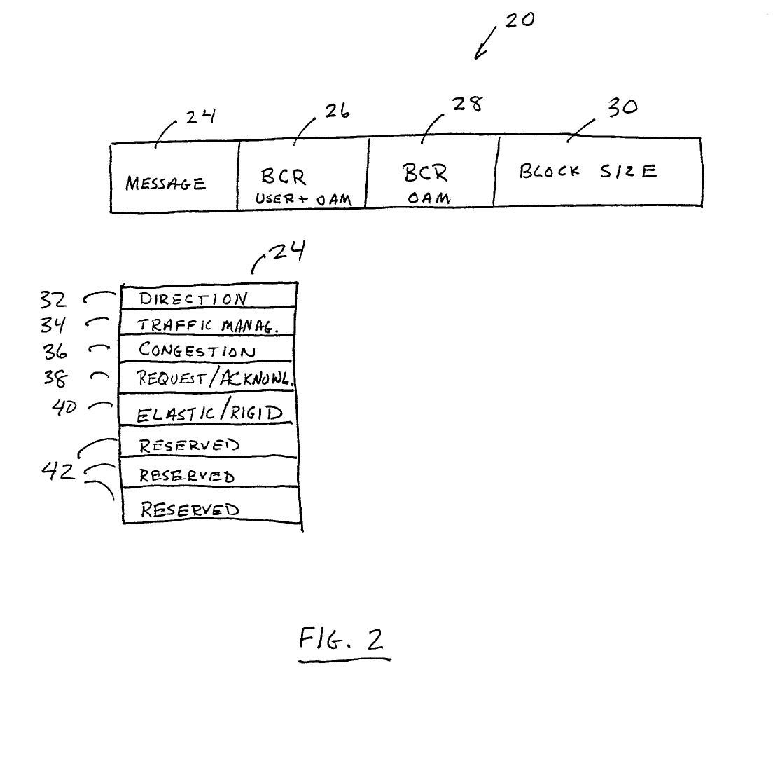

The cells include at least two types: resource management (RM) cells 20, illustrated in FIG. 2, and data cells. Data cells are generally fixed in size, although they may be variable, and contain digital information that represents a packet of information taken from a larger whole. For example, several data cells may contain the contents of a word processor file transmitted from one user at a computer coupled to a network 10 to another user on the network 10.

RM cells 20 describe characteristics desired for a given connection. They are initiated by a source system 14, a destination system 14, or a network node 12 to alter a given connection. Upon issuance, a RM cell 20 may propagate through each network node 12 in the forward and backward direction along the connection giving each node 12 and the source and destination systems 14 a chance to accept, reject, or alter the characteristics of the connection defined in the RM cell 20. When particular RM cells 20 delineate blocks of data cells for transmission, the connection is a block transfer. Block transfer may be implemented in a variety of ways including ATM block transfer (ABT) as described in International Telecommunications Union (ITU) Recommendation I.371, “Traffic Control and Congestion Control in B-ISDN,” Geneva, May, 1996. The connection characteristics are stored as bits within the RM cell 20, and the bits are stored in standardized fields within the RM cell 20 in such a manner that the bits are recognized by the end systems 14 and network nodes 12 coupled to the network 10. FIG. 2 depicts an example of fields within an RM cell. In one embodiment of the invention, each field includes one or more groups of eight bits known as octets, each bit or group of bits of which is available to describe an aspect of the connection characteristics.

According to FIG. 2, a rate of transmission of user-data plus user Operations-Administration-and-Maintenance (OAM) cells is specified by a block cell rate (BCR) field of bits 26 which occupies two octets. Similarly, a second rate of transmission for user OAM cells is specified in a second BCR field 28 which also occupies two octets. The values stored in the BCR fields 26 and 28 may be altered independently or together. Furthermore, a RM cell 20 may be configured to have a plurality of BCR fields corresponding to different types of data, affording the opportunity to negotiate for bandwidth with respect to each type. A block size field 30 indicates the size of a block of data to be transmitted. A message field 24 includes an octet, each bit of which specifies the type of RM cell 20 that is being transferred. A direction bit 32 specifies the direction for which the ABT RM cell 20 applies. A traffic management bit 34 specifies whether the RM cell 20 was issued by a network node 12 or an end system 14. A congestion indication bit 36 indicates whether a request for a desired BCR succeeded or failed. A request/acknowledgment bit 38 is used to distinguish request RM cells 20 that are sent to request or modify a connection from acknowledgment RM cells 20 that are sent by a network node 12 or end system 14 to respond to a request RM cell 20. An elastic/rigid bit 40 indicates whether the rate stored in the BCR field 26 or 28 of a request RM cell 20 may be changed by a network node 12 or end system 14 receiving the request RM cell 20, thus providing a toggle to enable or disable the flexible bandwidth negotiation capability described in the related U.S. patent application entitled “FLEXIBLE BANDWIDTH NEGOTIATION FOR THE BLOCK TRANSFER OF DATA”, filed Jun. 4, 1997, assigned to AT&T, and incorporated by reference herein. Three bits 42 of an octet within the message field 24 are reserved. These bits may be used to further distinguish message types or for other convenient purposes. In the following discussion and examples, BCR field 26 is utilized for illustration. However, it will be understood that BCR field 28 and any number of additional BCR fields present in a RM cell operate under the same principles as are hereinafter described.

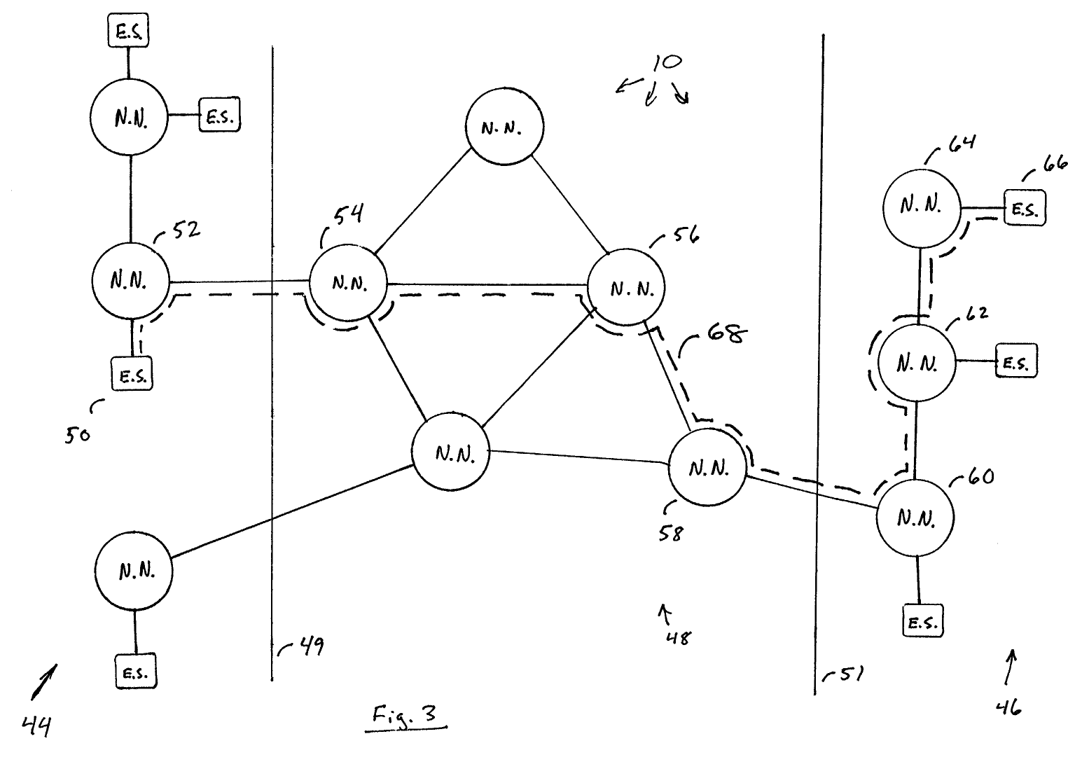

FIG. 3 illustrates a view of a particular network 10, in which two private networks at customer premises 44 and 46 are coupled to a public network 48. The public network 48 is a telecommunications network that offers telecommunication services to individuals and companies or organizations. Although the public network 48 is depicted as a single entity, the public network 48 may include a plurality of interconnected public networks. Each of the private networks, the public network 48, and each public network therein is in a separate administrative domain, where an administrative domain is a group of topologically contiguous network elements that are controlled by a single company or organization. Each of the private networks at the customer premises 44 and 46 include a plurality of network nodes 12 and end systems 14 that are coupled together.

Each of the private networks is a telecommunications network used by individuals or a corporation for internal telecommunications needs. The individuals or corporations may own all of the equipment that constitutes the private network, or a portion may be rented or leased. For example, the “link” between two private network nodes such as nodes 60 and 62 in FIG. 3 may be a fixed bandwidth semi-permanent connection (a digital private line) that is rented from a public network. In this scenario, the link between nodes 60 and 62 would traverse one or more public networks, and nodes 60 and 62 would function as end systems for this connection. Similarly, network nodes 60 and 62 shown in FIG. 3 could be connected via a semi-permanent block transfer virtual-path connection. In this scenario, network nodes 60 and 62 would function as end systems for a block transfer connection between nodes 60 and 62.

Separating the public network 48 and the private networks 44 and 46 are boundaries 49 and 51. The boundaries may represent, for example, user network interfaces (UNIs) as specified by the ITU. FIG. 3 highlights a connection 68, wherein an end system 50 is a source. The source 50 is coupled to a destination system 66 along the connection 68. The connection 68 traverses a private node 52 within the private network 44, public network nodes 54, 56, and 58 within the public network, and private network nodes 60, 62, and 64 on the destination side of the boundary 51 prior to reaching the destination end system 66. The connection 68 may be established in various ways including according to the ABT protocol and management and control planes thereof. When the connection 68 is established by the control plane it is a switched connection. Conversely, when the connection 68 is established by the management plane it is a semi-permanent connection.

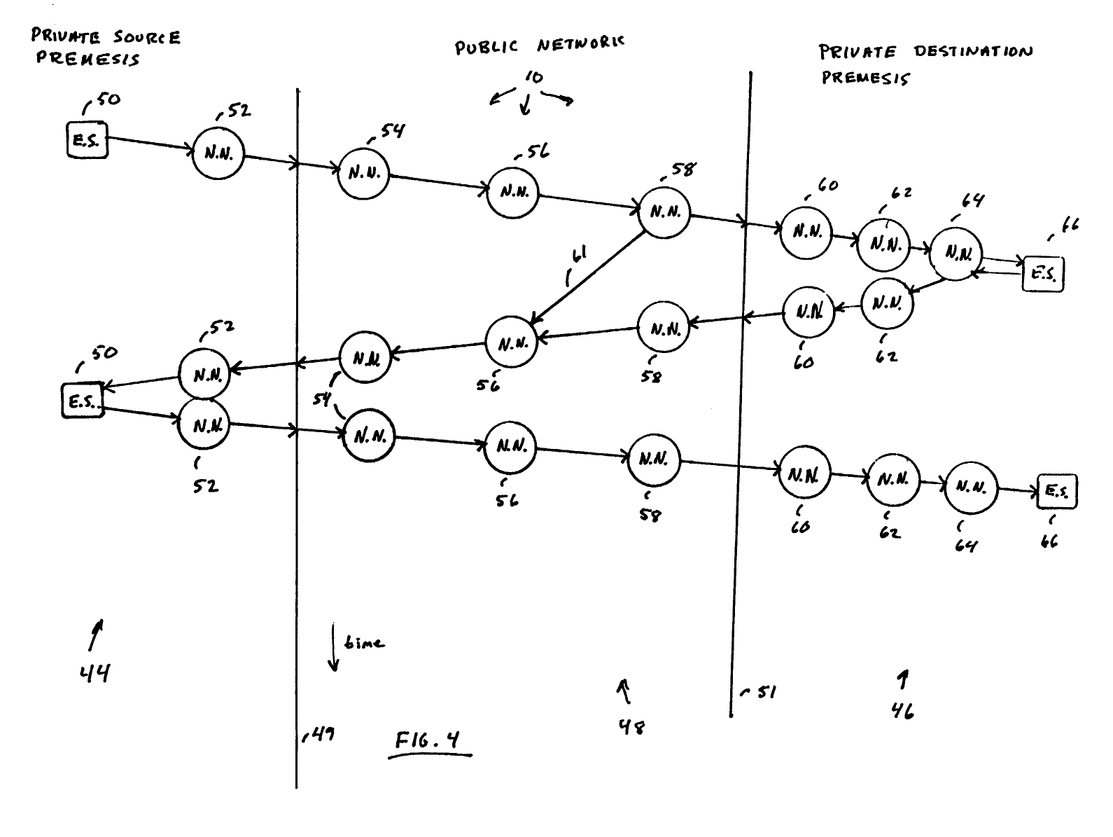

FIG. 4 illustrates an interaction between the source 50, and each network element along the connection 68 shown in FIG. 3, when the source 50 requests a bandwidth increase (the terms bandwidth, BCR, and rate are used interchangeably herein with respect to requesting a rate of transmission for a block of cells) for a forward connection. The source 50 emits a RM cell 20 requesting a rate corresponding to the value in the BCR field 26, which represents an increase over the rate presently allotted to the connection 68. Each network element along the connection 68 receives successively the RM cell 20 and makes a determination of whether to accept, reject, or alter the request before transmitting the RM cell 20 to the next node or end system.

One of the network elements may not be able to grant the bandwidth requested, for example because the bandwidth is not available due to a large volume of connections currently being handled. When this occurs, the network element rejects the request by, for example, setting the congestion indication bit 30 to “congestion”, setting the request/acknowledgment bit to “acknowledgment”, and transmitting the acknowledgment RM cell 20 back to the source. The rejecting network element also terminates the forward progress of the request RM cell 20.

Under the prior art, when all of the network elements along the connection 68 prior to the boundary 51 accept the request RM cell 20, the network node 58 on the public network side of the boundary 51: 1) transmits an acknowledgment RM cell 20 back to the Berger 4 source 50; and 2) transmits the original request RM cell 20 across the boundary 51 to the private destination network 46 for further acceptance or rejection. Once the acknowledgment RM cell is received at the source 50 from the node 58 along the path 61 shown in FIG. 3, the source begins to transmit blocks of data at the rate granted by the network nodes 52-58. Unfortunately, if any of the network elements 60-66 of the private destination network 46 reject the rate requested in the request RM cell 20, data sent from the source 50 at the higher rate may be lost at the private destination network 46.

According to the present invention, public network elements suppress initiating acknowledgment RM cells that represent acceptance of a request RM cell 20 initiated by the source 50, unless the accepting public network element is an end system. Therefore, referring to FIG. 3, when network node 58 receives and accepts a request RM cell 20 corresponding to the connection 68, the network node 58 does not initiate an acknowledgment RM cell. Rather, the public network node 58 forwards the request RM cell 20 across the boundary 51 to the private destination network 46 for further acceptance or rejection. If any network element within the private destination network 46 rejects the request, it sets the congestion indication bit to “congestion”, sets the request/acknowledgment bit to “acknowledgment”, and transmits the acknowledgment RM cell back to the source 50 along the connection 68. When this acknowledgment RM cell arrives at the source, it is the first acknowledgment RM cell received in response to the request RM cell 20. Therefore, unlike the prior art, the source 50 does not prematurely begin to transmit at the rate granted by the public network 48.

In an alternate embodiment of the invention, each network element along the connection 68 receives a RM cell 20 requesting additional bandwidth and determines the bandwidth that it has available to grant. If the bandwidth available to grant to the connection 68 is greater than the bandwidth currently allotted to the connection 68, but less than the requested rate, the network node rewrites the BCR field 26 of the RM cell 20 with the value the network node has determined to grant and forwards the RM cell 20 toward the destination 66. A variation of the last step is to include the case where the determined available bandwidth can be below the currently allotted bandwidth. If the elastic/rigid bit 40 in the RM cell request is set with a value corresponding to rigid, however, the network node without available bandwidth to satisfy the request will simply reject the request and generate an acknowledgment RM cell having, for example, the congestion bit 36 set to “congestion”.

When the RM cell 20 reaches the network node 58 of the public network 48 at the boundary 51, the network node 58 does not generate an acknowledgment RM cell unless it rejects the request. Instead, the request RM cell 20, having the original requested rate or a modified rate encoded in the BCR field 26 is forwarded across the boundary 51. Then, the request RM cell 20 is received by each network element within the private destination network 46, which can accept, reject, or further reduce the encoded rate. An acknowledgment RM cell is generated and sent from a point within the destination system 46 on the connection 68 in the backward direction. The point at which the acknowledgment RM cell is generated is either the point at which the request RM cell 20 is rejected or the end system 66. In the case of rejection, the acknowledgment RM cell is generated with the following settings: the request/acknowledgment bit 38 is set to “acknowledgment”; the direction bit 32 is set to “backward”; and the congestion bit 36 is set to “congestion”. Forward propagation of the request RM cell 20 is halted at the network element that generates the acknowledgment RM cell.

In one embodiment of the invention, the public or private network node that rejected the requested rate does not generate an acknowledgment RM cell. In this case, the original RM cell 20 is not terminated but is emitted on the forward connection with an indication that the request was denied, for example, by setting the congestion indication bit 36 to “congestion.” A subsequent network element then generates the acknowledgment RM cell on the companion backward connection.

Upon receipt of the acknowledgment RM cell, which travels in the backward direction toward the source 50 along the connection 68, each network node along the connection may determine that it lacks additional bandwidth to allocate for the requested increase in rate. In this event, a node may rewrite the value in the BCR field 26 of the RM cell 20 to a lower rate, which may be more or less than the original rate of the forward connection. Subsequently, the acknowledgment RM cell 20 reaches the source system 50 as shown in FIGS. 3 and 4.

In response to receiving the acknowledgment RM cell 20, updated as described by the network 10, the source 50 transmits a new forward RM cell 20 to the network 10 with a value in the BCR field 26 set to the rate contained within the acknowledgment RM cell 20 and subsequently transmits a block of data cells at up to the rate specified by the forward RM cell 20.

FIG. 4 illustrates bandwidth negotiation under a delayed transmission block transfer protocol (or scheme) where the source waits to receive an acknowledgment RM cell before increasing, possibly from zero the block cell rate. An example of such a block transfer protocol is provided by the ABT-delayed transmission (DT) transfer capability specified by the ITU.

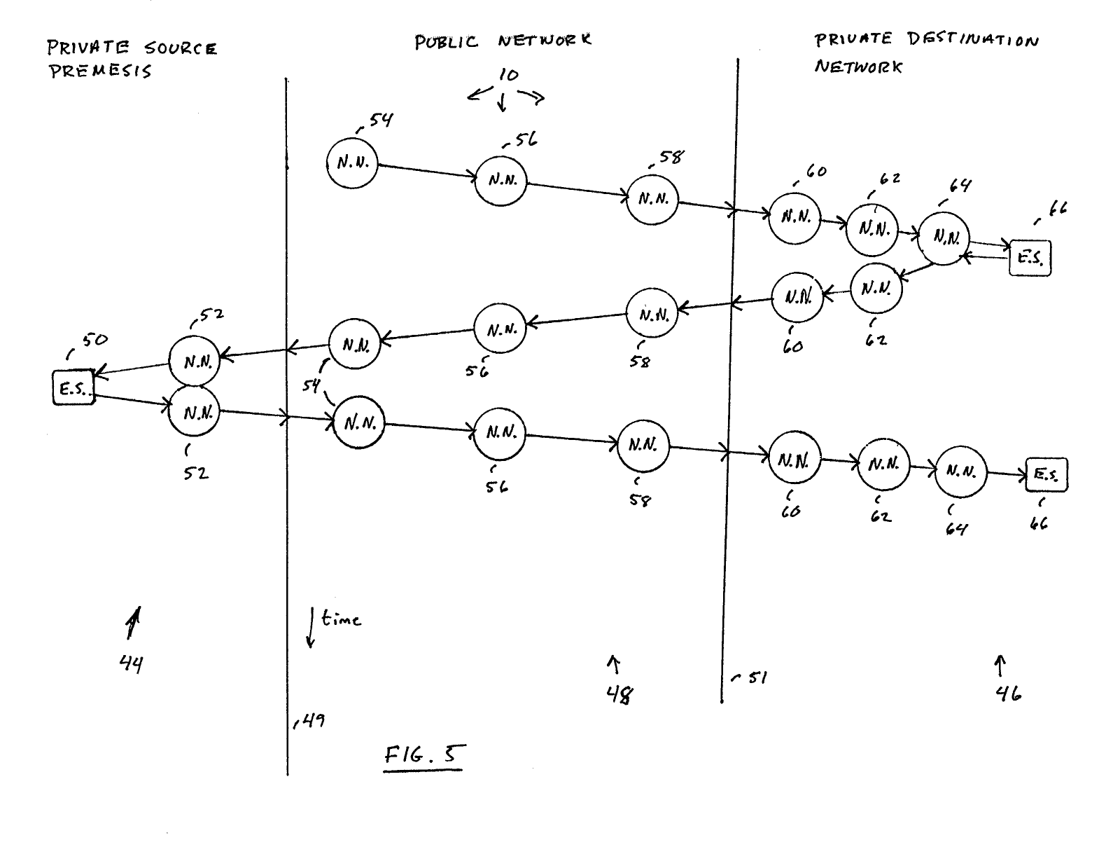

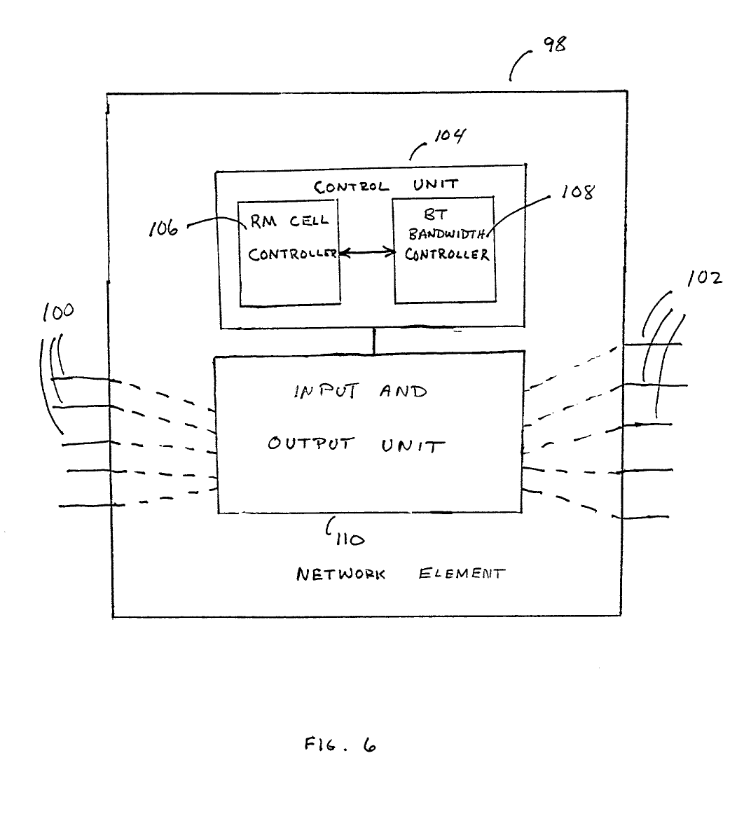

A bandwidth modification may also be initiated by a network node as shown in FIG. 5. The network node 54 emits a traffic management (TM) RM cell 20 having a traffic management bit 34 appropriately set, and value in the BCR field 26 that is higher than the current rate of the connection, representing an increase in the rate allocated to the connection. Upon receipt of RM cell 20, a network node can use a binary or a flexible-bandwidth-negotiation capability as previously described. In the latter case, each network node can reduce the value in the BCR field 26 and forward the RM cell 20 to the next node. Network node 58 sends a notification to the destination 66 along the connection 68. Under the prior art, an acknowledgment RM cell is also generated and sent to the source 50 by the network node 58 on the public network side of the boundary 51. Referring to the exploded view of a network element in FIG. 6, this boundary 51 is defined in International Telecommunications Union (ITU) Recommendation I.371 as being the egress link of a network element in a public network that is coupled to a private destination network.

Sending an acknowledgment RM cell from the network node 58 bypasses the network elements within the private destination network 46, each of which may deny the request or change the encoded BCR in response to the request RM cell 20. According to the present invention, the RM cell 20 continues to propagate until it reaches the destination end system 66. Only then is an acknowledgment RM cell generated and transmitted back to the source 50. The generated RM cell may have, for example: the request/acknowledgment bit 38 set to “acknowledgment”; the direction bit set to “backward”; and the traffic bit appropriately set. In addition, the rate in the BCR field 26 may be lowered by each network node along the connection 68. Thus, when the acknowledgment RM cell reaches the source 50, the acknowledgment RM cell has a value encoded in the BCR field 26 that reflects the lowest accepted rate of all network elements along the connection 68.

When the source end system 50 receives the acknowledgment RM cell 20, it initiates a forward acknowledgment RM cell 20 with the BCR value set to the BCR value in the received backward acknowledgment RM cell 20. Subsequently, the source 50 sends user data cells emitted at a rate no greater than the value specified in the BCR field 26. Network nodes can allocate resources according to the BCR value in the forward acknowledgment RM cell 20. Thus, if due to the prior network generated RM cell 20 or the prior backward acknowledgment RM cell 20, a network element has been tentatively reserving resources for a BCR whose value is greater than the resulting BCR value in the forward acknowledgment RM cell 20, then the network element can make the appropriate reduction in resources reserved.

FIG. 6 illustrates an expanded view of a network element 98. Consider first the case where the network element 98 is a network node. The network element 98 includes ingress links 100 and egress links 102 across which connections are established. Coupled to the ingress links 100 is an input and output unit 110 which is in turn coupled to a control unit 104. The input and output unit 110 may be implemented with widely known and available switching fabric and memory. The input and output unit 110 receives cells from the ingress links 100, exchanges control data with the control unit 104, and routes the cells from the ingress links 100 to the appropriate egress links 102 based on data received from the control unit 104. The control unit 104 receives RM cells 20 from the input and output unit 110 that pertain to a plurality of connections between various source and destination systems that pass through the input and output unit 110. The control unit 104 includes a RM cell controller 106 coupled to a block transfer (BT) bandwidth controller 108. The BT bandwidth controller 108 of the control unit 104 monitors the connections on the ingress links 100 and egress links 102 and determines the amount of bandwidth at the network element 98 to allocate to each connection.

When a RM cell 20 is received by a network element 98 over the ingress links 100, the RM cell controller 106 receives the RM cell 20 and transmits certain characteristics including the BCR to the BT bandwidth controller 108. If a bandwidth increase is requested, then the BT bandwidth controller 108 determines whether the requested BCR can be furnished. If not, but a lower rate is possible, then in flexible-bandwidth-negotiation the lower rate is transmitted back to the RM cell controller 106, which writes the possible rate into the BCR field 26 of the received RM cells 20. The RM cell 20 is then transmitted to the network 10 by the network element 98 through the input and output unit 110 and egress links 102 for further progress along the network 10.

For the case where the network element 98 is an end system, the network element 98 would have one, or only a few, ingress and egress links 100. However, the end system may not be the endpoint for user information that makes use of the ATM block transfer connection. Therefore, additional ingress and egress links for another networking technology may be included within the network element 98 to relay the user information via other networking technology toward the final destination. The BT controller unit 104 determines the amount of bandwidth the network element 98 can support for each established connection. When a RM cell 20 request for a bandwidth increase is received at the network element 98, the network element 98 takes the same action when it is an end system as when it is a network node. However, when an end system, the network element 98 does not forward the request RM cell 20, but rather only generates an acknowledgment RM cell 20 on the companion backward connection to inform the source 50 of the acceptance, at a particular BCR, or the rejection of the request.

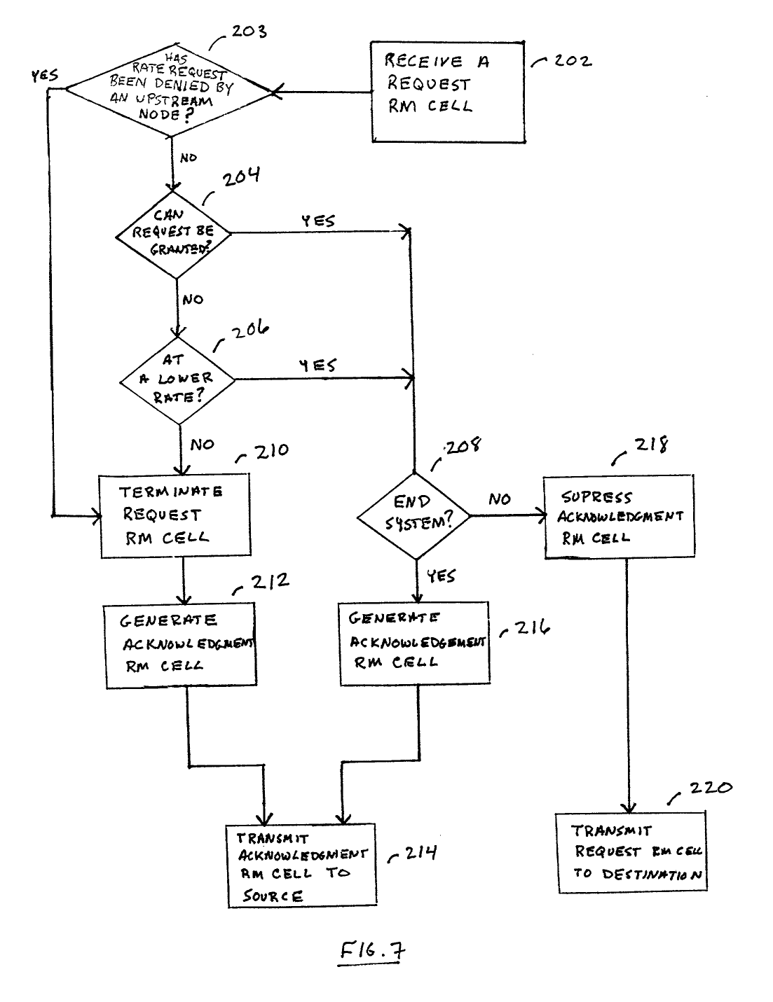

FIG. 7 illustrates a method according to the present invention. The method pertains to network elements 98 that are capable of generating acknowledgment RM cells. Moreover, the method handles the situation where a previous, upstream network node has denied the requested rate but does not generate an acknowledgment RM cell to inform the source 50. Instead, the network node forwards the request RM cell 20 toward the destination 66 with an indication that the request has been denied, for example by setting the congestion indication bit 36 to “congestion”.

In step 202 a network element 98 receives a RM cell 20 requesting a different connection rate for an established network connection. In step 203, a control unit 104 within the network element 98 determines whether the rate request encoded within the RM cell has been denied by an upstream node. If so, step 210 begins. If not step 204 begins. In step 204, the control unit 104 determines whether the requested rate stored in the BCR field 26 of the RM cell 20 can be granted. If the requested rate can be granted, then the step 208 begins. If the network element 98 is not implementing the flexible bandwidth negotiation capability, and the result of step 204 is “no” then step 210 begins and step 206 is omitted. Otherwise, in step 206, the control unit 104 determines a rate that the network element 98 has available to grant to the connection 68. Based on the determined rate, the control unit 104 determines whether to grant a lower rate than the requested rate.

If the control unit 104 determines to grant a lower or different rate in step 206, the rate stored in the BCR field 26 of the RM cell 20 is modified to reflect the granted rate. If not, the request embodied in the RM cell 20 is rejected and in step 210 the RM cell 20 is terminated, thus ceasing the progress of the RM cell 20 along the connection 68. In step 212 the control unit 104 generates an acknowledgment RM cell 20, in which the request/acknowledgment bit 38 is set to “acknowledgment”; the congestion bit 36 is set to “congestion”; and the direction bit 32 is set to “backward”. In step 214, the acknowledgment RM cell is sent to the input and output unit 110 for transmission over the egress links 102 along the connection toward the source.

If the rate request embodied in the BCR field 26 of the RM cell 20 is granted in step 204 or is granted at a lower rate in step 206, step 208 begins. In step 208, the network element 98 determines if it is an end system. If it is not an end system, step 218 begins. Conversely, if the network element 98 is an end system, it generates an acknowledgment RM cell 20 in step 216 having: the accepted rate encoded in the BCR field 26; the request/acknowledgment bit 38 set to “acknowledgment”; the congestion indication bit 36 set to “no congestion”; and the direction bit 32 set to “backward”. In step 214, the control unit 104 sends the acknowledgment RM cell to the input and output unit 110 for transmission over the egress links 102 along the connection toward the source.

In step 218, the control unit 104 suppresses the generation of an acknowledgment RM cell indicating that the requested rate has been granted or granted at a lower rate. In step 220, the RM cell 20 is transmitted along the network 10 toward the destination end system 66. Thus, each network element along the connection 68 has an opportunity to grant the requested rate in the BCR field 26 (or a decreased value) prior to the generation of a positive acknowledgment RM cell.

Although specific embodiments have been described, it will be understood by those having ordinary skill in the art that changes may be made to the embodiments without departing from the spirit and scope of the invention.

What is claimed is:

1. A network element within a network that includes first and second portions, the first and second portions of the network being within separate administrative domains, and the network element being within the first network portion, comprising: ingress and egress links coupling the first network portion to the second network portion, the second network portion including a destination for a block transfer connection path from a source, through the ingress and egress links, to the destination; and a control unit, coupled to the ingress and egress links, receiving from the first network portion a request cell having a rate request encoded therein, generating an acknowledgment cell in response to the request cell only if the rate request is denied, and transmitting the request cell along the connection path for review of the rate request.

2. The network element according to claim 1, wherein the control unit communicates to the source an acknowledgment cell received from the connection path traversing the second network portion.

3. The network element according to claim 1, wherein the rate request is denied by a node along the connection path between the source and the network element.

4. The network element according to claim 1, wherein the rate request is denied by the network element.

5. The network element according to claim 1, wherein the control unit modifies the encoded rate request and transmits the request cell with the modified encoded rate request along the connection path to the second network portion.

6. The network element according to claim 1, wherein the request cell is issued from the source or from a node along the connection path.

7. The network element according to claim 1, wherein the control unit incorporates asynchronous transfer mode block transfer protocols.

8. The network element according to claim 7, wherein the protocols include asynchronous transfer mode block transfer with delayed transmission.

9. The network element according to claim 1, wherein the first network portion is a public network.

10. The network element according to claim 1, wherein the second network portion is a private network.

11. The network element according to claim 1, wherein the request cell includes a plurality of rate requests encoded therein.

12. A method for propagating a rate request along a block transfer connection between a source and a destination, comprising the steps of: issuing to a network a request cell having a rate request encoded therein for a connection; transmitting the request cell along the connection and across a boundary of the network located between a public network portion and a private network portion thereof, the private network portion including the destination; generating an acknowledgment cell, in response to the request cell, only from within the private network portion of the network unless the rate request is rejected; and transmitting to the source on the network the acknowledgment cell indicating the status of the rate request.

13. The method according to claim 12, wherein the acknowledgment cell indicates that the rate request has been granted, granted at a lower rate, or denied.

14. The method according to claim 12, wherein the request cell in the issuing step issues from the source or a node on the network.

15. The method according to claim 12, wherein the network has a second private network portion that includes the source.

16. The method according to claim 12, wherein the method incorporates asynchronous transfer mode block transfer protocols.

17. The method according to claim 16, wherein the protocols include asynchronous transfer mode block transfer with delayed transmission.

18. The method according to claim 12, wherein the public network portion includes a plurality of public networks.

19. A method for propagating a rate request received at a network node along a block transfer connection, comprising the steps of: receiving from a network a request cell having a rate request encoded therein for a connection; determining whether to grant or reject the rate request; suppressing generation of an acknowledgment cell unless the rate request is rejected; and transmitting the request cell, for further review of the rate request, along the connection and across a boundary of the network located between a public network portion and a private network portion thereof, the private network portion including a destination system for the connection.

20. The method according to claim 19, wherein the rate request is rejected by an upstream node along the connection.

21. The method according to claim 19, wherein the rate request is rejected by the network node.

22. The method according to claim 19, further comprising the steps of: receiving from the private network portion of the network an acknowledgment cell; and transmitting the acknowledgment cell along the connection toward a source on the network.

23. The method according to claim 22, wherein the acknowledgment cell indicates that the rate request has been granted, granted at a lower rate, or denied.

24. The method according to claim 19, wherein the request cell received in the receiving step was issued from a source or a node on the network.

25. The method according to claim 19, wherein the method incorporates asynchronous transfer mode block transfer protocols.

26. The method according to claim 25, wherein the protocols include asynchronous transfer mode block transfer with delayed transmission.

27. A destination end system that acknowledges a rate request received from a forward block transfer connection, the forward block transfer connection coupling the destination end system to a source end system through a network along a connection path, comprising: an ingress link coupled to the forward block transfer connection; an egress link coupled to a backward block transfer connection that traverses the network along the connection path to the source; and a control unit, coupled to the ingress and egress link, receiving from the network through the ingress link a request cell having a rate request encoded therein for the forward block transfer connection, generating an acknowledgment cell based on the rate request, and emitting the acknowledgment cell to the source on the backward block transfer connection through the egress link.

28. The destination end system according to claim 27, wherein the control unit incorporates asynchronous transfer mode block transfer protocols.
